(19) United States
(12) Patent Application Publication
(10) Pub. No.: US 2026/0210400 A1
(43) Pub. Date: Jul. 23, 2026

(54) BUSH BEARING HAVING OPTIMIZED INTERMEDIATE PLATES

(71) Applicant: Vibracoustic SE, Weinheim (DE)

(72) Inventors: David Rose, Hamburg (DE); Jakob Frieß, Hamburg (DE); Ralf Steinhardt, Schwerin (DE)

(21) Appl. No.: 19/456,759

(22) Filed: Jan. 22, 2026

(30) Foreign Application Priority Data
Jan. 23, 2025 (DE) 10 2025 102 500.2

(51) Int. Cl. F16C 33/12

(52) U.S. Cl. CPC F16C 33/122; F16C 2208/10

(57) ABSTRACT

An elastomeric bush bearing includes a metallic core extending axially along a central longitudinal axis; an outer sleeve concentrical with the core; an elastomeric bearing body between the core and outer sleeve, and connected to them by vulcanization, with two longitudinal recesses extending the length of the bearing body and situated opposite in a first radial direction are formed in the bearing body; and two intermediate plates vulcanized into the bearing body, each comprises at least one circular portion extending over at least 135° in the circumferential direction in a circular shape around a partial-circle centre in a section plane perpendicular to the central longitudinal axis. The bearing body may comprise outer and inner elastomer tracks for each intermediate plate. The intermediate plates may each have two portions angled in the direction of a second radial direction perpendicular to the first radial direction and that extend into the longitudinal recesses.

### CROSS-REFERENCE TO RELATED APPLICATION

This application claims priority to German Patent Application No. DE 10 2025 102 500.2, filed on January 23, 2025, the contents of which is hereby incorporated by reference in its entirety.

### TECHNICAL FIELD

The invention relates to elastomeric bush bearings.

### BACKGROUND

Elastomeric bush bearings are known in the art. CN103241086A, for example, relates to an elastomeric bush bearing slotted on both sides and having two partially circular intermediate plates. One major problem of this design is the heavy concentration of strain in the central gap region of the elastomeric bearing body, especially in the case of radial loading perpendicular to the gap. The excess strain can lead to excess stress in the elastomer and, as a result, to premature component failure.

In addition, JP4832344B2 likewise relates to an elastomeric bush bearing having partially circular intermediate plates but having a bulbous core and intermediate plate. Despite a high radial and axial stiffness, this solution may exhibit additional loading of the elastomer in the central region on account of the bulbous widened portions, thereby likewise giving rise to an increase in strain and to possible damage.

CN112555315A furthermore describes a bush configuration with intermediate plates over only part of the circumference. The stiffness varies considerably between the radial directions since the elastomer tracks are unequally distributed. Although the angled ends of the intermediate plates on the outside of the intermediate plates increase stiffness in one direction, they impair stiffness in the orthogonal direction and may lead to non-uniform load distribution, which may likewise lead to premature failure.

### SUMMARY

It is an object of the invention to overcome these and other disadvantages of the prior art and to provide an improved elastomeric bush bearing which offers high radial stiffness values and, at the same time, has improved functionality as well as a longer life.

Aspects and features of the invention are disclosed herein.

In the case of an elastomeric bush bearing comprising a metallic core, which extends axially along a central longitudinal axis, an outer sleeve arranged concentrically with the core, an elastomeric bearing body arranged between the core and the outer sleeve and connected to them by vulcanization, wherein two longitudinal recesses extending over the entire length of the bearing body in the axial direction and situated opposite in a first radial direction are formed in the bearing body, two intermediate plates, which are vulcanized into the bearing body and each comprise at least one circular portion, which extends over at least 135° in the circumferential direction in a circular shape around a partial-circle centre in a section plane perpendicular to the central longitudinal axis, wherein the bearing body comprises an outer elastomer track and an inner elastomer track for each intermediate plate, wherein the intermediate plates each have two portions angled in relation to the circular portions, it is envisaged according to aspects and teachings of the invention that the angled portions of the intermediate plates may be angled in the direction of a second radial direction perpendicular to the first radial direction and extend perpendicularly or almost perpendicularly into the longitudinal recesses of the bearing body.

The longitudinal recesses, which extend completely through the bearing body in the axial direction, can for example be of identical design. In this case, the longitudinal recesses can extend in a first radial direction from the metallic core in the direction of the outer sleeve. Further, the longitudinal recesses can have identical cross-sectional shapes or recess shapes and/or can extend in an identical manner in the first radial direction from the core in the direction of the outer sleeve, wherein the longitudinal recesses can have a substantially square or rectangular cross-sectional shape. The longitudinal recesses can extend parallel to flat side surfaces of the core in an axial direction. The intermediate plates extending in the circumferential direction around the longitudinal recesses can then be angled with their angled portions in the direction of a second radial direction perpendicular to the first radial direction and can extend perpendicularly or almost perpendicularly into the longitudinal recesses of the bearing body.

By means of a solution according to the disclosure, a bush bearing is provided, the terminally formed intermediate plates of which give a geometry that is almost closed in the circumferential direction when pressed in. The configuration provides a bush geometry which allows similar stiffness values in the radial direction to those in the prior art but may be distinguished by lower excess strains or strain concentrations in the region of the gap by virtue of the angled portions, which are perpendicular or arranged almost perpendicularly. In the prior art, these excess strains are caused, in particular, by a displacement of the elastomer in the presence of radial loading perpendicular to the gap. In the present case, “almost circumferential” should be understood to mean that the intermediate plates may be spaced apart when not pressed in but may be brought very close to one another by means of calibration of the outer sleeve and/or by the process of pressing in. In this case, however, there may still be a small spacing between the angled portions or between the two intermediate plates, even in the calibrated and/or pressed-in state.

By virtue of the angled portions according to the disclosure of the intermediate plates, which may be angled in the direction of a second radial direction perpendicular to the first radial direction and extend perpendicularly or almost perpendicularly into the longitudinal recesses of the bearing body, the stress distribution in the elastomer may be advantageously significantly improved since the perpendicular or almost perpendicular orientation of the portions controls the elastomer body more uniformly in the presence of radial loads in both orthogonal directions. This selectively reduces excess strains, especially in the region of the inner elastomer track or in the central region of the gap, where critical stress concentrations often occur in the prior art, as in the case, for instance, of the partially circular intermediate plates described at the outset. At the same time, the arrangement according to the disclosure of the intermediate plates and angled portions can contribute to increased rotational symmetry, ensuring more uniform stiffness in all radial directions. This is advantageous particularly in the case of applications with cyclical or dynamic loads since non-uniform deformations and material fatigue are minimized. In addition, the perpendicular or almost perpendicular embedding in the longitudinal recesses may enable more stable anchoring of the intermediate plates, as a result of which their positioning during loading remains precise. Overall, this geometry can lead to an improved life, increased mechanical stability and optimum force transmission in the elastomeric bush bearing.

According to an embodiment, the angled portions can extend almost perpendicularly into the longitudinal recesses of the bearing body in such a way that they can be formed slightly inwards in the direction of the core in the first radial direction, deviating from the circular shape, with respect to a circle circumference of the circular portions. The angled portions of the intermediate plates extend almost perpendicularly into the longitudinal recesses and enable controlled load transfer. Their orientation inwards in the second radial direction ensures uniform stress distribution in the elastomer, thereby reducing excess strains and increasing the life. Since the excess strains tend to occur in the central region on the inner elastomer track if the inner and outer elastomer tracks have the same elastomer track thickness, it is advantageous if the inner elastomer track is made thicker than the outer elastomer track. Accordingly, the inner elastomer track can be of thicker design than the outer elastomer track. In addition, the portions angled radially inwards in the direction of the core have a particularly positive effect in respect of the stiffness values and the displacement of the elastomer, further reducing the strain concentration.

According to another variant embodiment of the inventive concept, the angled portions can each be subject to angling at one point on the circle circumference. The angled portions can extend in such a way that, at the point, they can each enclose an angle of no more than 20°, preferably an angle of no more than 15°, with respect to a tangent to the circle circumference of the circular portions. Thus, both angled portion pairs of the intermediate plates that face one another by way of their circumferential end surfaces in the longitudinal recesses enclose 40° overall (preferably 30° overall). The radially inwardly formed portions with a limited angle can have a particularly advantageous effect. The slight inward angling of the portions gives rise to an optimized geometry which harmonically distributes the stresses. The limitation of the angle to a maximum of 20° (preferably a maximum of 15°) minimizes material fatigue and increases the efficiency of force transmission, while the structural integrity of the system is maintained. If, namely, the gap were significantly larger, the stiffness values in the two radial directions arranged perpendicularly to one another would, on the one hand, differ greatly, and, on the other hand, the excess strains due to displacement of the elastomer would be expected particularly in the central region in the middle of the inner elastomer track. This is advantageously counteracted by the defined maximum limits.

According to another embodiment, the angled portions of the intermediate plates can extend into the longitudinal recesses in such a way that, at the end faces of the intermediate plates, their extents can make up overall in total a maximum of 60°, preferably a maximum of 40°, as a further preference a maximum of 32°, of a circle circumference around the partial-circle centre. Their extents in the central regions of the intermediate plates can preferably make up overall in total a maximum of 90°, preferably a maximum of 80°, of a circle circumference around the partial-circle centre. The limitation of the total extent to a maximum of 60° (preferably 40°) at the end faces and to a maximum of 90° (preferably 80°) in the central regions ensures a precise balance between flexibility and stiffness or stability. This improves the load distribution and reduces local overloads in the elastomer.

It may be preferred that, at their end faces, the intermediate plates can have a region exhibiting rotational symmetry around the longitudinal axis amounting overall in total to at least 270° in the circumferential direction, preferably at least 300° in the circumferential direction. A high rotational symmetry of at least 270° (preferably 300°) leads to uniform radial stiffness in all directions. This reduces stress peaks and ensures improved torsional strength, increasing the stability of the bush bearing in the presence of dynamic loads. Thus, the region of the intermediate plates with rotational symmetry corresponds to at least 270° or 3/4 of the circle circumference, or 300° or 5/6 of the circle circumference in a preferred embodiment. This high rotational symmetry leads to similar radial stiffness values as in the prior art but likewise offers good torsional properties at the same time. Here, good torsional properties mean low excess strains in the angled portions.

According to another preferred embodiment, the opposite longitudinal recesses can close in such a way during the calibration of the outer sleeve and/or during the mounting of the bush bearing that the mutually facing end surfaces of the angled portions of the intermediate plates move towards one another. In this case, it is possible to arrange a spacing between the end surfaces, which spacing may be no more than twice as great as the wall thickness of the intermediate plates, preferably no more than 1.5 times as great as the wall thickness of the intermediate plates. The possibility of closing the longitudinal recesses during the calibration or mounting of the bush bearing ensures better adaptation and reduced noise and vibration. The controlled spacing between the end surfaces ensures optimum elastomer deformation and avoids excess stress concentrations.

According to another embodiment, the longitudinal recesses can extend completely through the outer and inner elastomer tracks of the bearing body in the first radial direction. The longitudinal recesses can extend completely radially from the core to the outer sleeve, wherein, for manufacturing reasons, the surfaces of the outer sleeve, of the core and of the intermediate plates can be covered with thin rubber skins. As a further preference here, the rubber skins can have a thickness of about 0.6 mm to 1 mm. The complete radial extent of the longitudinal recesses through inner and outer elastomer tracks ensures better separation of the load regions. This reduces stress concentrations in the elastomer and ensures uniform force transmission between the core, the outer sleeve and the intermediate plates.

The outer sleeve can preferably be of closed design over its entire lateral surface or can have longitudinal slots which correspond to the longitudinal recesses and which can extend in the axial direction over the entire length of the outer sleeve. A closed outer sleeve offers high structural integrity and prevents the ingress of dirt or moisture. Alternatively, longitudinal slots improve flexibility of assembly and allow application-specific adaptation.

According to a preferred embodiment, the core can be of substantially cylindrical design and can have a bulbous or spherical central region. The bulbous or spherical central region can serve to optimize and guide the elastomer deformation under axial and radial loads.

The core can have two radially opposite flat side surfaces, which face the longitudinal recesses. The bulbous or spherical central region of the core can be flattened in the region of the longitudinal recesses by virtue of the side surfaces. The flat side surfaces and the flattened central region minimize excess strains in the region of the longitudinal recesses and ensure controlled deformation. Moreover, the flattening of the bulbous or spherical central region improves the fit and stability.

According to another variant embodiment, the core can have at least two relief grooves, which, in relation to the central longitudinal axis, can be arranged in a manner axially offset with respect to the spherical central regions of the core. The relief grooves reduce local stress peaks, especially in the case of radial loads perpendicular to the longitudinal recesses, and increase the flexibility of the system. Their axial arrangement on both sides of the spherical central regions leads to a reduction in the strains in the elastomer that are observed due to the elastomer being displaced outwards in the axial direction under radial loading. As a result, they prevent excessive loads in the elastomer.

The relief grooves can be formed in part in the circumferential direction and can be oriented in a manner offset by 90° in the circumferential direction with respect to the flat side surfaces of the core. The 90° offset of the relief grooves in the circumferential direction ensures selective stress relief and a defined orientation which improve the structural integrity of the bush bearing and simultaneously reduce material stress.

According to another embodiment, the inner elastomer tracks can each be arranged between the core and an intermediate plate. The outer elastomer tracks can each be arranged between an intermediate plate and the outer sleeve. In this case, a thickness of the inner elastomer tracks may be no more than 30%, preferably no more than 20%, greater than a thickness of the outer elastomer tracks, wherein this greater thickness is to be found in at least 50% of the extent of the elastomer tracks, preferably in at least 80% of the extent of the elastomer tracks. The respective thicknesses can be measured along a radial vector which is arranged perpendicularly to the central longitudinal axis and runs through the greatest radial extent of the bulbous or spherical central region. Adapting the thickness ratios of the elastomer tracks can optimize the deformation properties and load transfer. This may lead to better utilization of the elastomer and increased load-bearing capacity in specific applications.

According to a preferred embodiment, the end surfaces of the angled portions of the intermediate plates relate to the intermediate plates and have a straight course in the axial direction along the central longitudinal axis. The end surfaces which relate to an elastomer layer of the bearing body can have demoulding bevels in the axial direction along the central longitudinal axis. The combination of straight end surfaces (of the intermediate plates) in the axial direction and demoulding bevels (on the covered elastomer layer) allows simple assembly and prevents unwanted stress accumulations in the elastomer, especially in the central gap region. This furthermore improves ease of assembly and functionality.

The longitudinal extent of the intermediate plates in the axial direction can be less than the longitudinal extent of the relief grooves in the axial direction. As a result, the axial ends of the intermediate plates are each positioned on both sides in the region of a relief groove, and therefore the axial ends of the intermediate plates are further away from the core during cardanic movements of the bearing than would be the case without relief grooves. A smaller longitudinal extent of the intermediate plates thus reduces strain peaks in the elastomer and advantageously increases the flexibility of the bush bearing. This optimizes the adaptability of the system for dynamic radial and cardanic loads and increases its life.

According to another embodiment of the inventive concept, central regions of the intermediate plates can be of bulbous or spherical design, wherein the position of the bulbous or spherical central regions of the intermediate plates, when considered in the axial direction, can be of corresponding design to the spherical central region of the core. The bulbous or spherical design of the central regions of the intermediate plates, which is configured so as to correspond to the geometry of the spherical central region of the core, offers several technical advantages. This shaping optimizes the adaptation of the intermediate plates to the deformation of the elastomeric bearing body under load, in particular under cardanic loading. By virtue of the corresponding configuration, a uniform strain distribution in the elastomer tracks between the core, the intermediate plates and the outer sleeve is achieved, effectively reducing strain peaks in the material. Moreover, as a positive, the spherical or bulbous shape may allow a lower cardanic stiffness overall than is achieved with cylindrical intermediate plates. This can lead to greater driving comfort and a reduction in material fatigue and thus improves the overall life and, at the same time, the NVH performance of the bush bearing.

### BRIEF DESCRIPTION OF THE DRAWINGS

Further features, details and advantages of the invention will be apparent from the wording of the claims and also from the description below of exemplary embodiments with reference to the drawings, in which:

FIG. 1a shows a schematic plan view of a first embodiment of a bush bearing according to aspects and teachings of the invention with two intermediate plates extending over at least 135° in the circumferential direction in a section plane perpendicular to the central longitudinal axis;

FIG. 1b shows a schematic enlarged view of the bush bearing from FIG. 1a;

FIG. 2a shows a schematic illustration of a core of the bush bearing according to an embodiment of the invention in a perspective longitudinal view;

FIG. 2b shows a schematic illustration of the core from FIG. 2a with two intermediate plates in a perspective longitudinal view;

FIG. 2c shows a schematic illustration of the core from FIG. 2a with two intermediate plates in a perspective longitudinally sectioned view;

FIG. 2d shows a schematic illustration of the core from FIG. 2a with two intermediate plates in a perspective cross-sectional view;

FIG. 2e shows a schematic illustration of the core from FIG. 2a with two intermediate plates in a longitudinally sectioned view; and

FIG. 3 shows a schematic plan view of another embodiment of a bush bearing according to aspects and teachings of the invention with two intermediate plates extending over at least 135° in the circumferential direction in a section plane perpendicular to the central longitudinal axis.

### DETAILED DESCRIPTION

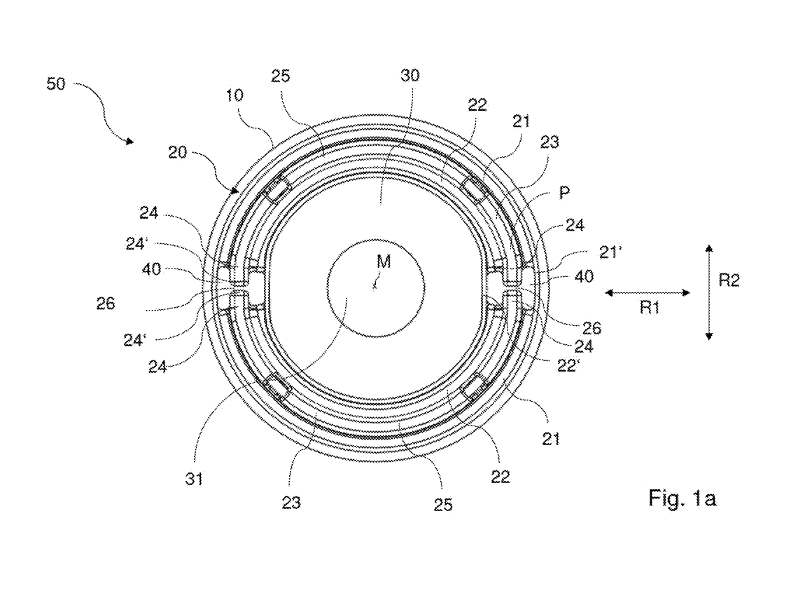

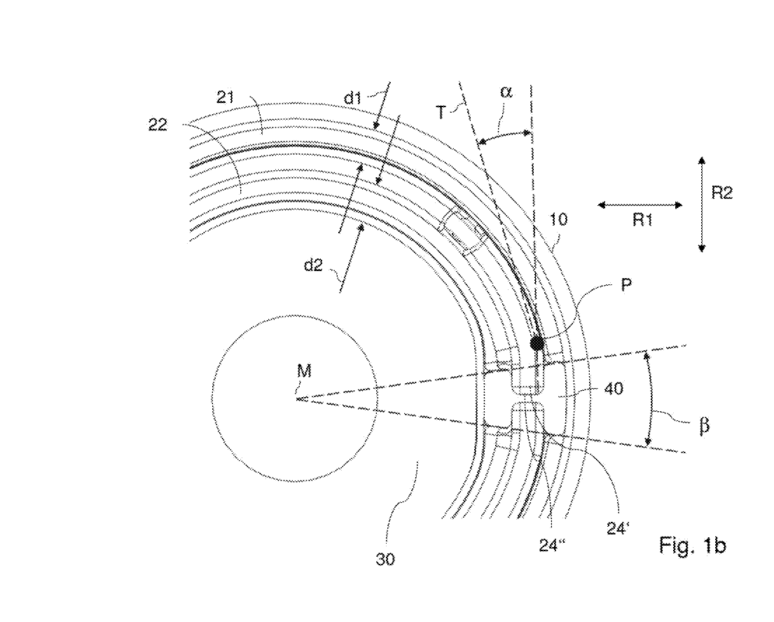

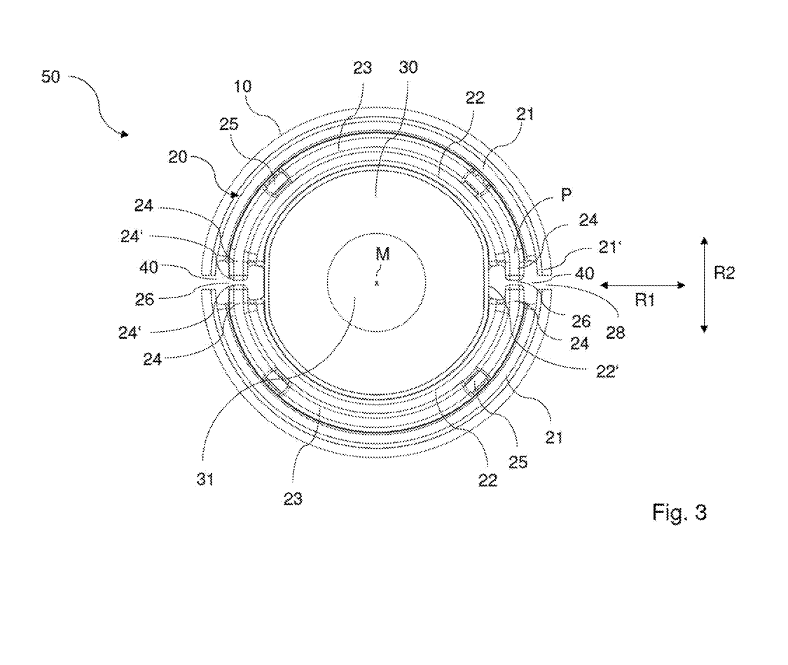

The elastomeric bush bearing denoted in general by 50 in FIG. 1 and FIG. 3 is a bearing which comprises a metallic core 30 that extends axially along a central longitudinal axis L.

An outer sleeve 10 is arranged concentrically with respect to the core 30, and an elastomeric bearing body 20 is arranged between the core 30 and the outer sleeve 10. The bearing body 20 is connected to the core 30 and the outer sleeve 10 by vulcanization.

Two longitudinal recesses 40, which extend over the entire length of the bearing body 20 in the axial direction A and lie opposite one another in a first radial direction R1, are formed in the bearing body 20.

Two intermediate plates 25 are vulcanized into the bearing body 20. Each intermediate plate 25 comprises at least one circular portion 23, which extends around a partial-circle centre M over at least 135° in the circumferential direction U in a section plane perpendicular to the central longitudinal axis L.

For each intermediate plate 25, the bearing body 20 may comprise an outer elastomer track 21 and an inner elastomer track 22. The intermediate plates 25 may each have two angled portions 24, which are angled in the direction of a second radial direction R2 perpendicular to the first radial direction R1 and extend perpendicularly or almost perpendicularly into the longitudinal recesses 40 of the bearing body 20.

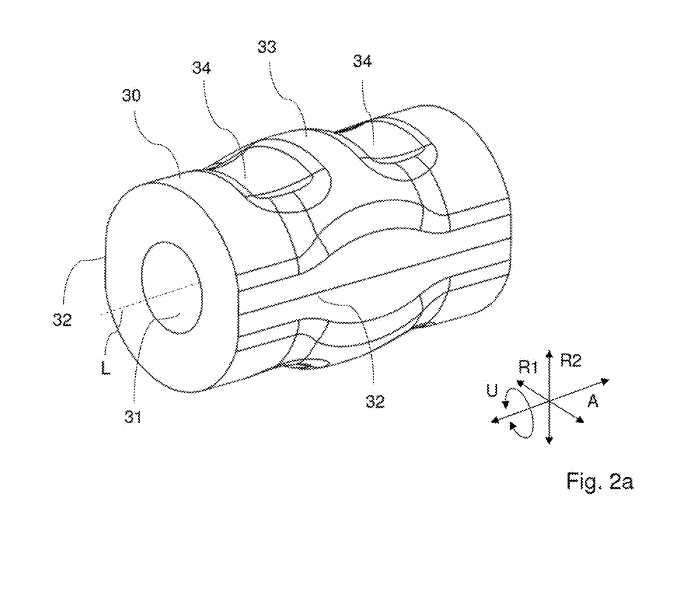

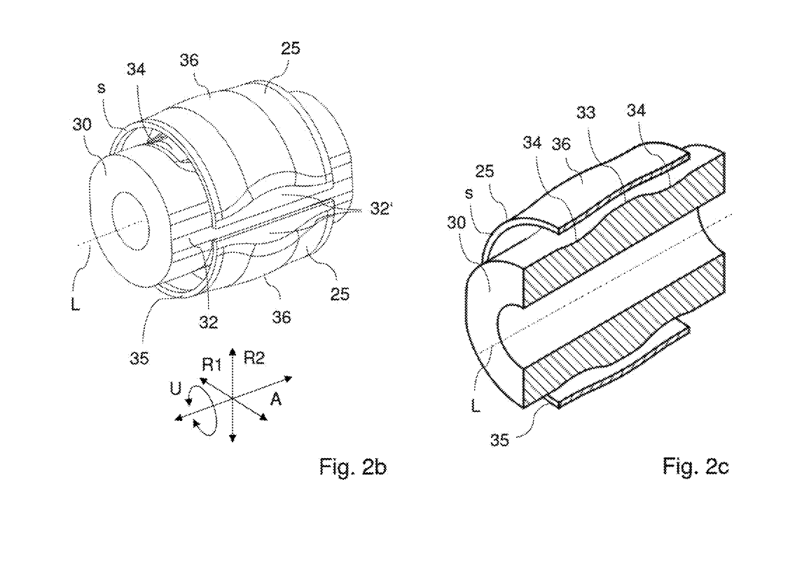

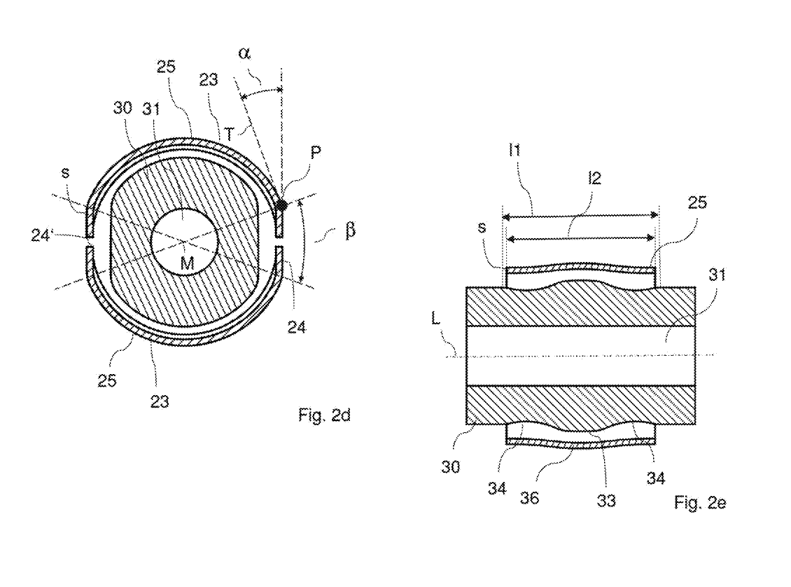

As can be seen, in particular, by additionally referring to FIG. 1b and FIG. 2d, the angled portions 24 extend almost perpendicularly into the longitudinal recesses 40 in such a way that they are formed slightly inwards in the direction of the core 30 in the first radial direction R1, deviating from the circular shape with respect to a circle circumference of the circular portions 23.

As can furthermore be seen in FIG. 1b, the angled portions 24 may each be subject to angling at one point P on the circle circumference and extend in such a way that, with embodiments at the point P, they each enclose an angle α of no more than 20°, preferably no more than 15°, with respect to a tangent T to the circle circumference of the circular portions 23.

The angled portions 24 can extend into the longitudinal recesses 40 in such a way that, at the end faces 35 of the intermediate plates 25, in embodiments, their extents can make up overall a maximum of 60°, preferably a maximum of 40°, as a further preference a maximum of 32°, of a circle circumference around the partial-circle centre M.

In this context, “overall” refers to both angled portion pairs 24, which extend into the radially opposite longitudinal recesses 40. In other words, in embodiments, the angled portions 24 make up a maximum of 30°, preferably a maximum of 20°, as a further preference a maximum of 16°, of a circle circumference around the partial-circle centre M on each longitudinal recess side. The extents in the central regions 36 of the intermediate plates 25 can preferably make up in total a maximum of 90°, preferably a maximum of 80°, of a circle circumference around the partial-circle centre M.

At their end faces 35, the intermediate plates 25 can have a region exhibiting rotational symmetry around the longitudinal axis L amounting overall in total to at least 270° in the circumferential direction U, preferably at least 300°.

The longitudinal recesses 40 situated opposite in the radial direction R1 can close in such a way during the calibration of the outer sleeve 10 and/or during the mounting of the bush bearing 50 that the mutually facing end surfaces 24’ and 24’’ of the angled portions 24 of the intermediate plates 25 move towards one another. A spacing between the end surfaces 24’ under 24’’ may preferably be no more than twice as great as the wall thickness s of the intermediate plates 25, more preferably no more than 1.5 times as great as the wall thickness s of the intermediate plates 25.

As can be seen, in particular, in FIG. 1b, the end surfaces 24’ relate to the surfaces of the intermediate plates 25, and the end surfaces 24’’ relate to the applied elastomer layer.

The core 30 can be of substantially cylindrical design and can comprise a bulbous or spherical central region 33 (see, for example, FIG. 2a).

FIG. 2b and FIG. 2c illustrate the fact that the intermediate plates 25 can have central regions 36 which can likewise be of bulbous or spherical design. When viewed in the axial direction A, the position of the bulbous or spherical central regions 36 of the intermediate plates 25 can be of corresponding design to the spherical central region of the core.

The longitudinal recesses 40 can extend completely through the outer elastomer tracks 21 and the inner elastomer tracks 22 of the bearing body 20 in the first radial direction R1, and can extend completely radially from the core 30 to the outer sleeve 10.

The outer sleeve 10 can be of closed design over its entire lateral surface or can have longitudinal slots 28 which extend in the axial direction A over the entire length of the outer sleeve 10 (see, for example, FIG. 3).

The core 30 can have two radially opposite flat side surfaces 32, which face the longitudinal recesses 40 and correspond to the angled portions 24 as regards the mutually facing surfaces. The bulbous or spherical central region 33 of the core 30 can be flattened in the region of the longitudinal recesses 40 by virtue of the side surfaces 32 (see, for example, FIG. 2a).

The core 30 can have at least two relief grooves 34, which, in relation to the central longitudinal axis L, are arranged in a manner axially offset with respect to the spherical central regions 33 of the core 30 (see, for example, FIG. 2e).

The relief grooves 34 can be formed in part in the circumferential direction U and can be oriented in a manner offset by 90° in the circumferential direction U with respect to the flat side surfaces 32 of the core 30.

The inner elastomer tracks 22 can be arranged between the core 30 and an intermediate plate 25, while the outer elastomer tracks 21 can be arranged between an intermediate plate 25 and the outer sleeve 10. The thickness d2 of the inner elastomer tracks 22 may be no more than 30%, preferably no more than 20%, greater than the thickness d1 of the outer elastomer tracks 21 (see, for example, FIG. 1b).

The end surfaces 24’ of the angled portions 24 of the intermediate plates 25 can have a straight course in the axial direction A along the central longitudinal axis L, while the end surfaces 24’’ relate to an elastomer layer of the bearing body 20 and can have demoulding bevels in the axial direction A along the central longitudinal axis L.

The longitudinal extent l2 of the intermediate plates 25 in the axial direction A may be less than the longitudinal extent l1 of the relief grooves 34 in the axial direction A (see, for example, FIG. 2e).

The invention is not restricted to the embodiments described above and instead can be modified in various ways. Various “preferential” numerical dimensions herein may be exemplary only, and in the context of different disclosed variants/embodiments.

All the features and advantages that are apparent from the claims, the description and the drawing, including structural details, spatial arrangements and method steps, may be essential to the invention both individually and in a very wide variety of combinations.

1. An elastomeric bush bearing, comprising:
a metallic core, which extends axially along a central longitudinal axis;
an outer sleeve arranged concentrically with the core;
an elastomeric bearing body arranged between the core and the outer sleeve and connected to them by vulcanization, wherein two longitudinal recesses extending over an entire length of the bearing body in the axial direction and situated opposite in a first radial direction are formed in the bearing body; and
two intermediate plates that are vulcanized into the bearing body and each comprise at least one circular portion, which extends over at least 135° in a circumferential direction in a circular shape around a partial-circle centre in a section plane perpendicular to the central longitudinal axis;
wherein the bearing body comprises an outer elastomer track and an inner elastomer track for each intermediate plate; the intermediate plates each have two portions angled in relation to the circular portions; and the angled portions of the intermediate plates are angled in the direction of a second radial direction perpendicular to the first radial direction and extend perpendicularly or almost perpendicularly into the longitudinal recesses of the bearing body.

2. The elastomeric bush bearing according to claim 1, wherein the angled portions extend almost perpendicularly into the longitudinal recesses of the bearing body in such a way that the angled portions are formed slightly inwards in the direction of the core in the first radial direction, deviating from the circular shape, with respect to a circle circumference of the circular portions.

3. The elastomeric bush bearing according to claim 2, wherein the angled portions are each subject to angling at one point on the circle circumference, and the angled portions of the intermediate plates extend such that, at the point, the angled portions each enclose an angle of no more than 20° with respect to a tangent to the circle circumference of the circular portions.

4. The elastomeric bush bearing according to claim 2, wherein the angled portions are each subject to angling at one point on the circle circumference, and the angled portions of the intermediate plates extend such that, at the point, the angled portions each enclose an angle of no more than 15°, with respect to a tangent to the circle circumference of the circular portions.

5. The elastomeric bush bearing according to claim 3, wherein the angled portions extend into the longitudinal recesses such that, at end faces of the intermediate plates, their extents make up overall in total a maximum of 60° of a circle circumference around the partial-circle centre, and/or that their extents in central regions of the intermediate plates make up overall in total a maximum of 90° of the circle circumference around the partial-circle centre.

6. The elastomeric bush bearing according to claim 3, wherein the angled portions extend into the longitudinal recesses such that, at end faces of the intermediate plates, their extents make up overall in total a maximum of 40° of a circle circumference around the partial-circle centre, and/or that their extents in central regions of the intermediate plates make up overall in total a maximum of 80° of the circle circumference around the partial-circle centre.

7. The elastomeric bush bearing according to claim 1, wherein, at their end faces, the intermediate plates have a region exhibiting rotational symmetry around the longitudinal axis amounting overall in total to at least 270° in the circumferential direction.

8. The elastomeric bush bearing according to claim 1, wherein, at their end faces, the intermediate plates have a region exhibiting rotational symmetry around the longitudinal axis amounting overall in total to at least 300° in the circumferential direction.

9. The elastomeric bush bearing according to claim 1, wherein the opposite longitudinal recesses close such that during calibration of the outer sleeve and/or during mounting of the bush bearing that mutually facing end surfaces of the angled portions of the intermediate plates move towards one another, wherein there is a spacing between the end surfaces of the angled portions after closure of the longitudinal recesses, which spacing is no more than twice as great as a wall thickness of the intermediate plates.

10. The elastomeric bush bearing according to claim 1, wherein the opposite longitudinal recesses close such that during calibration of the outer sleeve and/or during mounting of the bush bearing that mutually facing end surfaces of the angled portions of the intermediate plates move towards one another, wherein there is a spacing between the end surfaces of the angled portions after closure of the longitudinal recesses, which spacing is no more than 1.5 times as great as a wall thickness of the intermediate plates.

11. The elastomeric bush bearing according to claim 1, wherein the longitudinal recesses extend completely through the outer and inner elastomer tracks of the bearing body in the first radial direction, and wherein the longitudinal recesses extend completely radially from the core to the outer sleeve.

12. The elastomeric bush bearing according to claim 1, wherein the outer sleeve is of closed design over its entire lateral surface or has longitudinal slots which correspond to the longitudinal recesses and which extend in the axial direction over the entire length of the outer sleeve.

13. The elastomeric bush bearing according to claim 1, wherein the core is of substantially cylindrical design, and wherein the core has a bulbous or spherical central region.

14. The elastomeric bush bearing according to claim 13, wherein the core has two radially opposite flat side surfaces, which face the longitudinal recesses; and wherein the bulbous or spherical central region of the core is flattened in the region of the longitudinal recesses by virtue of the side surfaces.

15. The elastomeric bush bearing according to claim 13, wherein the core has at least two relief grooves; and wherein, in relation to the central longitudinal axis, the relief grooves are arranged in a manner axially offset with respect to the spherical central regions of the core.

16. The elastomeric bush bearing according to claim 15, wherein the relief grooves are formed in part in the circumferential direction; and wherein the relief grooves are oriented in a manner offset by 90° in the circumferential direction with respect to flat side surfaces.

17. The elastomeric bush bearing according to claim 13, wherein the inner elastomer tracks are each arranged between the core and an intermediate plate, and the outer elastomer tracks are each arranged between an intermediate plate and the outer sleeve, wherein a thickness of the inner elastomer tracks is no more than 30% greater than a thickness of the outer elastomer tracks, and wherein the respective thicknesses are measured along a radial vector which is arranged perpendicularly to the central longitudinal axis and runs through the greatest radial extent of the bulbous or spherical central region.

18. The elastomeric bush bearing according to claim 13, wherein the inner elastomer tracks are each arranged between the core and an intermediate plate, and the outer elastomer tracks are each arranged between an intermediate plate and the outer sleeve, wherein a thickness of the inner elastomer tracks is no more than 20% greater than a thickness of the outer elastomer tracks, and wherein the respective thicknesses are measured along a radial vector which is arranged perpendicularly to the central longitudinal axis and runs through the greatest radial extent of the bulbous or spherical central region.

19. The elastomeric bush bearing according to claim 9, wherein the end surfaces of the angled portions relate to the intermediate plates and have a straight course in the axial direction along the central longitudinal axis, and wherein the end surfaces relate to an elastomer layer of the elastomeric bearing body and have demoulding bevels in the axial direction along the central longitudinal axis.

20. The elastomeric bush bearing according to claim 15, wherein a longitudinal extent of the intermediate plates in the axial direction is less than a longitudinal extent of the relief grooves in the axial direction.
